(19) United States
(12) Patent Application Publication
(10) Pub. No.: US 2023/0126678 A1
(43) Pub. Date: Apr. 27, 2023

(54) PYTHON-BASED INTEGRATED MANAGEMENT METHOD AND SYSTEM OF URBAN CUSTOMIZED WEATHER DATABASE

(71) Applicant: National Institute of Meteorological Sciences, Seogwipo-si (KR)

(72) Inventors: Dong Won YI, Seoul (KR); Hee Wook CHOI, Seogwipo-si (KR); Seung Wook LEE, Seogwipo-si (KR); Sung Hwa PARK, Seogwipo-si (KR)

(21) Appl. No.: 17/973,434

(22) Filed: Oct. 25, 2022

(30) Foreign Application Priority Data
Oct. 26, 2021 (KR) 10-2021-0143209

(51) Int. Cl. G01W 1/10; G06F 16/29

(52) U.S. Cl. CPC G01W 1/10; G06F 16/29

(57) ABSTRACT

Disclosed is a Python-based integrated management method of an urban customized weather database for constructing urban weather observation data as an integrated database. The method includes the steps of: storing raw urban weather observation data collected from a plurality of urban weather observation networks as first files of a predetermined format according to an order of observation time at each observation point of the urban weather observation networks; extracting data of each observation point of the urban weather observation networks from the stored first files according to the order of observation time, for a predetermined weather element and analysis period; masking observation values belonging to a predetermined masking condition, among observation values included in the extracted data; and storing the masking-processed data as a second file.

### BACKGROUND OF THE INVENTION

### Field of the Invention

The present disclosure relates to an integrated management method and system of a weather database, and more particularly, to an integrated management method and system of an urban customized weather database.

### Cross Reference to Related Application of the Invention

The present application claims the benefit of Korean Patent Application No. 10-2021-0143209 filed in the Korean Intellectual Property Office on Oct. 26, 2021, the entire contents of which are incorporated herein by reference.

### Background of the Related Art

In modern times, as industrialization and urbanization progress in many countries, the number of people living in cities has increased significantly. In the cities of a large population, social and economic damage occurs every year due to abnormal meteorological phenomena. In addition, meteorological phenomena such as heat waves and cold waves are affecting the demand for heating and cooling in Korea, which is located in the mid-latitude region with distinct seasonal characteristics, and the efficiency of using the heating and cooling. Accordingly, it is important to accurately analyze meteorological phenomena of a medium or less scale occurring in cities, predict future urban meteorological phenomena based on the urban meteorological data, or control urban infrastructures.

Recently, the National Institute of Meteorological Sciences in Korea has constructed observation networks that can measure various meteorological variables in major metropolitan areas such as Seoul, Gyeonggi-do, and the like, and is making efforts to provide accurate observation data on the urban meteorological phenomena.

However, since these observation networks have different types of data collected from each observation network, and there is a difference in the contents of the collected and stored data, there is a limit in that the overall urban weather observation data is difficult to access, and its utilization is low.

### SUMMARY OF THE INVENTION

An object of the present disclosure is to provide a method and system for constructing an urban customized weather database that consistently stores data of different urban weather observation networks, and managing the database in an integrated manner.

The technical problems to be solved in this specification are not limited to the technical problems mentioned above, and unmentioned other technical problems will be clearly understood by those skilled in the art from the following descriptions.

To accomplish the above object, according to one aspect of the present invention, there is provided a Python-based integrated management method of an urban customized weather database, the method for constructing urban weather observation data into an integrated database, and comprising the steps of: storing raw urban weather observation data collected from a plurality of urban weather observation networks as first files of a predetermined format according to an order of observation time at each observation point of the urban weather observation networks; extracting data of each observation point of the urban weather observation networks from the stored first files according to the order of observation time, for a predetermined weather element and analysis period; masking observation values belonging to a predetermined masking condition, among observation values included in the extracted data; and storing the masking-processed data as a second file.

In an embodiment, the urban weather observation networks may include Road Weather Information (RWI), Surface Energy Balance (SEB), Integrated Meteorological Sensor (IMS), and Urban-Boundary-Green (UBG).

In an embodiment, the predetermined format may include a CSV format, and as many first files as a number (n×y) obtained by multiplying the number (n) of all observation points included in the urban weather observation networks by the number (y) of observation periods per year may be stored.

In an embodiment, the predetermined weather element may include at least one weather element selected from a group configured of air temperature, wind direction, wind speed, maximum wind direction, maximum wind speed, daily precipitation, atmospheric pressure, rainfall detection, hourly precipitation, humidity, road surface condition, net radiation, total radiation, reflected radiation, water film thickness, salt concentration, solar radiation, downward shortwave radiation, upward shortwave radiation, downward longwave radiation, upward longwave radiation, underground temperature, road surface temperature, freezing point temperature, infrared surface temperature, contact-type surface temperature (south), contact-type surface temperature (north), net shortwave radiation, net longwave radiation, albedo, water vapor pressure, soil heat flux, soil temperature, soil moisture, average wind direction per minute, average wind speed per minute, soil average temperature, average east-west wind, average north-south wind, east-west wind anomaly, north-south wind anomaly, average wind speed anomaly, average soil moisture, daily maximum temperature, daily minimum temperature, daily maximum humidity, daily minimum humidity, daily maximum wind speed, and daily maximum wind direction.

In an embodiment, the predetermined analysis period may include an annual period.

In an embodiment, the step of storing as first files of a predetermined format according to an order of observation time may include the step of storing, when there is a plurality of observation values for one weather element for each observation point at the same observation time, only one of the observation values for the weather element.

In an embodiment, the predetermined masking condition may include masking, among the extracted observation values, negative values, values exceeding 75, and values of which the difference from a previous observation value is greater than 10 as missing values when the predetermined weather element is wind speed, masking, among the extracted observation values, values smaller than -90 and values greater than 60 as missing values when the predetermined weather element is air temperature, and masking, among the extracted observation values, negative values as missing values when the predetermined weather element is not wind speed nor air temperature.

In an embodiment, the second file may further include a ratio of non-missing values among all observation values with respect to the predetermined weather element.

A computing system according to an embodiment of the present disclosure is configured to implement a Python-based integrated management method of an urban customized weather database for constructing urban weather observation data as an integrated database.

According to the method and system for managing an urban customized weather database in an integrated manner according to the present disclosure, observation data collected from different urban weather observation networks may be stored as sorted and integrated data, and accordingly, users may easily access and use urban weather data.

The effects that can be obtained from the present invention are not limited to the effects mentioned above, and unmentioned other effects will be clearly understood by those skilled in the art from the following descriptions.

### BRIEF DESCRIPTION OF THE DRAWINGS

The accompanying drawings, which are included as part of the detailed description to help the understanding of the present invention, provide embodiments of the present invention, and describe technical features of the present invention, together with the detailed description.

FIG. 1 is a view showing geographic distribution of urban weather observation networks used in an integrated management method of an urban customized weather database according to an embodiment of the present disclosure.

FIG. 2 is a flowchart illustrating an integrated management method of an urban customized weather database according to an embodiment of the present disclosure.

FIG. 3 is a view conceptually showing an integrated management method of an urban customized weather database according to an embodiment of the present disclosure.

FIG. 4 is a view conceptually showing the architecture of an integrated urban customized weather database using an integrated management method of an urban customized weather database according to an embodiment of the present disclosure.

FIG. 5 is a view showing an example of a weather element database constructed according to an integrated management method of an urban customized weather database according to an embodiment of the present disclosure.

FIG. 6 is a view showing a Python-based pseudo code for implementing an integrated management method of an urban customized weather database according to an embodiment of the present disclosure.

### DETAILED DESCRIPTION OF THE PREFERRED EMBODIMENT

Hereinafter, embodiments of the present disclosure will be described in detail with reference to the accompanying drawings.

The terms used throughout this disclosure may have a meaning of a nuance suggested or implied in the context beyond the meaning mentioned explicitly.

Phrases such as “in one embodiment” and “in an exemplary embodiment” used in this disclosure do not necessarily refer to the same embodiment, and phrases such as “in another embodiment” or “in another exemplary embodiment” may or may not necessarily refer to another embodiment.

The terms such as “and”, “or”, and “and/or” used in this disclosure may include various meanings that may depend, at least in part, on the context in which such terms are used.

According at least in part to the context, the term such as “one or more” used in this disclosure may be used to describe an arbitrary feature, structure, or characteristic in a singular sense, or may be used to refer to a feature, a structure, or a combination of these in a plural sense.

In addition, the terms such as “based on”, “in reaction to”, and “in response to” are not intended to transfer a set of exclusive factors, but to permit presence of an additional factor that is not explicitly stated, according at least in part to the context.

In addition, expressions such as “first” and “second” used in the present disclosure may modify various components regardless of the order and/or importance, and are only used to distinguish one component from another, and do not limit the components.

Unless defined otherwise, all technical and scientific terms used in this disclosure have the same meaning as commonly understood by those skilled in the art.

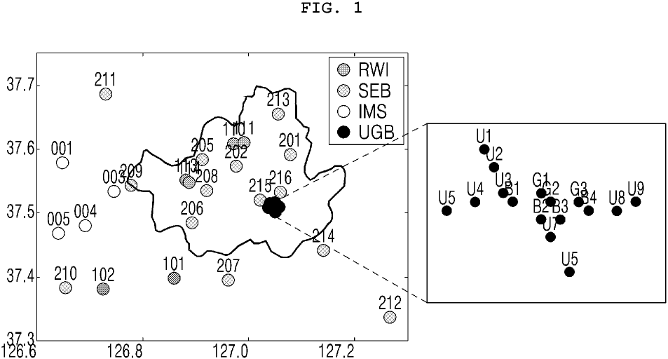

FIG. 1 is a view showing geographic distribution of urban weather observation networks used in an integrated management method of an urban customized weather database according to an embodiment of the present disclosure.

Referring to FIG. 1, the National Institute of Meteorological Science in Korea operates observation devices for measuring various weather elements (air temperature, humidity, wind direction, wind speed, atmospheric pressure, precipitation, etc.) at a plurality of locations in Seoul and neighboring metropolitan areas since 2018. These observation networks for acquiring weather data of high-spatial resolution in the urban areas include: Road Weather Information (RWI), Surface Energy Balance (SEB), Integrated Meteorological Sensor (IMS), and Urban-Boundary-Green (UBG). The locations of the observation points of each observation network are shown in Table 1.

TABLE 1

| Identification number | Observation network | Observation point ID | Latitude | Longitude |
|---|---|---|---|---|
| 1 | RWI | 101 | 37.3969 | 126.8602 |
| 2 | RWI | 102 | 37.3805 | 126.7265 |
| 3 | RWI | 110 | 37.6068 | 126.9738 |
| 4 | RWI | 111 | 37.6096 | 126.9919 |
| 5 | RWI | 113 | 37.551 | 126.8833 |
| ⋯ | ⋯ | ⋯ | ⋯ | ⋯ |
| 36 | UBG | U5 | 37.508 | 127.038 |
| 37 | UBG | U6 | 37.501 | 127.051 |
| 38 | UBG | U7 | 37.505 | 127.049 |
| 39 | UBG | U8 | 37.508 | 127.056 |
| 40 | UBG | U9 | 37.509 | 127.058 |

These observation networks are configured to commonly observe air temperature, humidity, wind direction, and wind speed, which are basic elements needed for weather observation, while observing additional weather elements different from each other according to the operating purpose of each observation network. For example, RWI is configured to observe air temperature, wind direction, wind speed, maximum wind direction, maximum wind speed, daily precipitation, atmospheric pressure, rainfall detection, hourly precipitation, humidity, road surface condition, net radiation, total radiation, reflected radiation, water film thickness, salt concentration, solar radiation, downward shortwave radiation, upward shortwave radiation, downward longwave radiation, upward longwave radiation, underground temperature, road surface temperature, freezing point temperature, and the like.

For example, SEB is configured to observe atmospheric pressure, rainfall, infrared surface temperature, contact-type surface temperature (south), contact-type surface temperature (north), upward shortwave radiation, downward shortwave radiation, upward longwave radiation, downward longwave radiation, net shortwave radiation, net longwave radiation, net radiation, albedo, net radiometer temperature, air temperature, humidity, water vapor pressure, wind direction, wind speed, instantaneous maximum wind speed, soil heat flux, soil temperature, and soil moisture, and the like.

For example, IMS is configured to observe atmospheric pressure, air temperature, humidity, wind direction, wind speed, rainfall, and the like.

For example, UBG is configured to observe average wind direction per minute, maximum wind direction, average wind speed per minute, average wind speed, maximum wind speed, air temperature, humidity, atmospheric pressure, soil moisture, soil average temperature, average net radiation, net radiation, average east-west wind, average north-south wind, east-west wind anomaly, north-south wind anomaly, average wind speed anomaly, average soil moisture, daily maximum temperature, daily minimum temperature, daily maximum humidity, daily minimum humidity, daily maximum wind speed, daily maximum wind direction, and the like.

Observation data obtained from these observation networks are transmitted to and accumulated in a server managed by the National Institute of Meteorological Sciences in Korea according to the data collection type and method of each observation network.

The formats of the observation data collected from each of the observation networks are different from each other. Therefore, in order to analyze geographical distribution of air temperature using urban weather observation data of the observation points in Seoul and neighboring metropolitan areas, there is a problem in that these different observation data should be separately collected and processed.

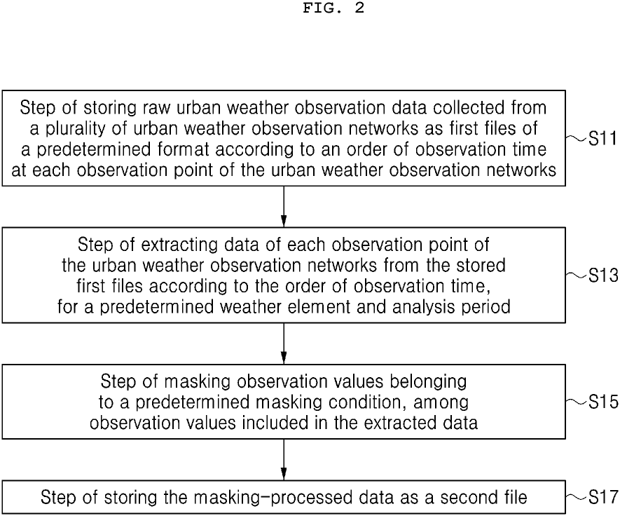

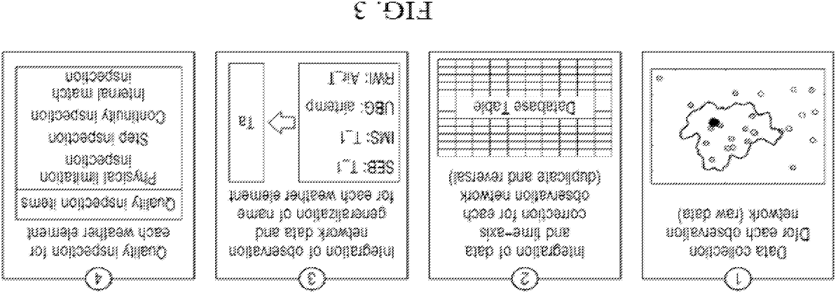

FIG. 2 is a flowchart illustrating an integrated management method of an urban customized weather database according to an embodiment of the present disclosure. FIG. 3 is a view conceptually showing an integrated management method of an urban customized weather database according to an embodiment of the present disclosure.

Referring to FIGS. 2 and 3, an integrated management method of an urban customized weather database according to an embodiment of the present disclosure is a Python-based integrated management method of an urban customized weather database for constructing urban weather observation data as an integrated database. The integrated management method includes the steps of: storing raw urban weather observation data collected from a plurality of urban weather observation networks as first files of a predetermined format according to the order of observation time at each observation point of the urban weather observation networks (S11); extracting data of each observation point of the urban weather observation networks from the stored first files according to the order of observation time, for a predetermined weather element and analysis period (S13); masking observation values belonging to a predetermined masking condition, among observation values included in the extracted data (S15); and storing the masking-processed data as a second file (S17).

At step S11, the raw urban weather observation data collected from a plurality of urban weather observation networks may be stored as first files of a predetermined format according to the order of observation time at each observation point of the urban weather observation networks. The plurality of urban weather observation networks may include Road Weather Information (RWI), Surface Energy Balance (SEB), Integrated Meteorological Sensor (IMS), and Urban-Boundary-Green (UBG) operated by the National Institute of Meteorological Sciences.

At this point, the raw urban weather observation data collected from the urban weather observation networks may include variables corresponding to weather elements and information on the observation points constituting a corresponding urban weather observation network (e.g., observation point ID). Such weather elements and observation point information may be included in the header portion of the first files.

Accordingly, as the raw urban weather observation data of any one observation network is accumulated for an entire observation period, the raw city weather observation data may be stored for each observation point as data of a form arranged in rows (weather elements) and columns (observation values according to observation time). At this point, the format of the stored first files may be a format such as comma separated value (CSV), TXT, DAT, or the like.

In general, although the observation time period of the urban weather observation networks used in the embodiments of the present disclosure may be 1 minute, 5 minutes, 10 minutes, 30 minutes, or the like, it may vary according to the observation period of the observation networks. For example, when the weather element is daily precipitation, observation values may be collected every 24 hours.

Meanwhile, step S11 may include the step of storing, when there is a plurality of observation values for one weather element for each observation point at the same observation time, only one of the observation values for the weather element. That is, due to the data communication error or the like in the observation network, a plurality of observation values may exist at the same observation time for the weather elements collected from one observation point of the urban weather observation networks, and in this case, only one observation value may be stored as data in the first file, and other observation values may be ignored. For example, when there are several pairs of observation values observed at the same observation time, only the observation values collected first may be stored as data in the first file.

A plurality of first files may be stored by applying this process to all data collected from each urban weather observation network. Specifically, as many first files as a number (n×y) obtained by multiplying the number (n) of all observation points included in the urban weather observation networks by the number (y) of observation periods per year are stored. For example, when the number of all observation points included in the four observation networks of RWI, SEB, IMS, and UBG is 40 (n = 40), and the observation period is between Jan. 1, 2018 and Dec. 31, 2020 (y = 3), a total of 120 first files of CSV format may be stored.

At step S13, data of each observation point of the urban weather observation networks may be extracted from the stored first files according to the order of observation time for a predetermined weather element and analysis period.

Here, the predetermined weather element may include at least one weather element selected from a group configured of air temperature, wind direction, wind speed, maximum wind direction, maximum wind speed, daily precipitation, atmospheric pressure, rainfall detection, hourly precipitation, humidity, road surface condition, net radiation, total radiation, reflected radiation, water film thickness, salt concentration, solar radiation, downward shortwave radiation, upward shortwave radiation, downward longwave radiation, upward longwave radiation, underground temperature, road surface temperature, freezing point temperature, infrared surface temperature, contact-type surface temperature (south), contact-type surface temperature (north), net shortwave radiation, net longwave radiation, albedo, water vapor pressure, soil heat flux, soil temperature, soil moisture, average wind direction per minute, average wind speed per minute, soil average temperature, average east-west wind, average north-south wind, east-west wind anomaly, north-south wind anomaly, average wind speed anomaly, average soil moisture, daily maximum temperature, daily minimum temperature, daily maximum humidity, daily minimum humidity, daily maximum wind speed, and daily maximum wind direction.

Here, the predetermined analysis period may include an annual period. For example, the analysis period may be an annual period, such as 2018, 2019, or 2020.

For example, when the database is constructed based on the Python programming language, the analysis period for constructing the database may be specified, for example, as a list such as [‘2018’, ‘2019’, ‘2020’], and observation values for a predetermined weather element (e.g., wind speed) corresponding thereto may be extracted from the first files.

At step S15, observation values belonging to a predetermined masking condition among the observation values included in the extracted data may be masking-processed.

Here, when the weather element predetermined at step S13 is wind speed, the predetermined masking condition may be masking, among the extracted observation values, negative values, values exceeding 75, and values of which the difference from a previous (e.g., 10 minutes) observation value is greater than 10 as missing values (e.g., 9999, NaN, etc.).

Additionally or alternatively, when the weather element predetermined at step S13 is air temperature, the predetermined masking condition may be masking, among the extracted observation values, values smaller than -90 and values greater than 60 as missing values.

Additionally or alternatively, when the weather element predetermined at step S13 is not wind speed nor air temperature, the predetermined masking condition may be masking, among the extracted observation values, negative values as missing values.

As described above, as all values having a value that is difficult to occur in an urban area in Korea as an observation value in the real physical world are masking-processed as a missing value, reliability of the urban weather observation data used for analyzing actual urban weather phenomena may be improved. In addition, the inconvenience that a user using the database should apply separate filtering, masking, and the like can be solved.

At step S17, the masking-processed data may be stored as one second file. The second file may further include a ratio of non-missing values (i.e., normal observation values) among all observation values (i.e., all observation values before being masking-processed) for a predetermined weather element (e.g., wind speed) as header information. For example, in the case of wind speed among the observation values of the weather elements collected from a specific observation point, excluding missing values among the observation values between Jan. 1, 2018 and Dec. 31, 2020, a value of 80.76, which indicates that only 80.76% of the observation values during the entire 3-year analysis period are actual observation values, may be included in the header.

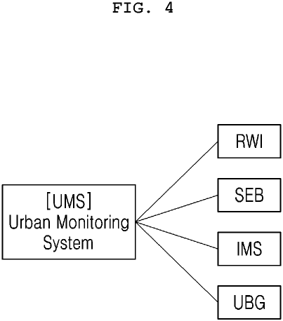

FIG. 4 is a view conceptually showing the architecture of an integrated urban customized weather database using an integrated management method of an urban customized weather database according to an embodiment of the present disclosure. Referring to FIG. 4, it can be seen that the urban customized weather database constructed in the integrated management method of an urban customized weather database may be implemented in a way of integrating data of the four urban weather observation networks operated for different purposes into one database.

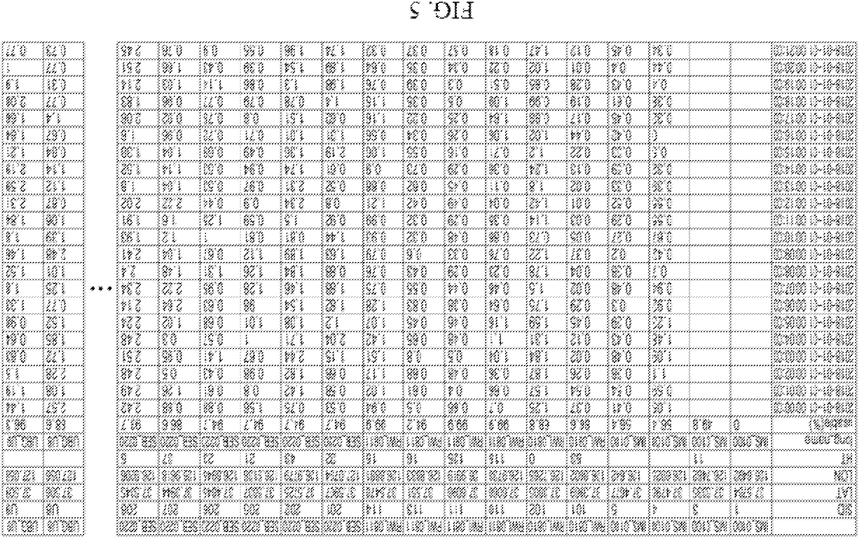

FIG. 5 is a view showing an example of a weather element database constructed according to an integrated management method of an urban customized weather database according to an embodiment of the present disclosure. Referring to FIG. 5, the ID, the latitude (LAT) , the longitude (LON), the height, and the ratio of available observation values (usability) of an observation point are included as a header file for each observation point of the four observation networks of RWI, SEB, IMS, and UBG (column title), and observation values of wind speed observed from 00:00 on Jan. 1, 2018 to 23:59 on Dec. 31, 2020 may be stored in one file (e.g., CSV file).

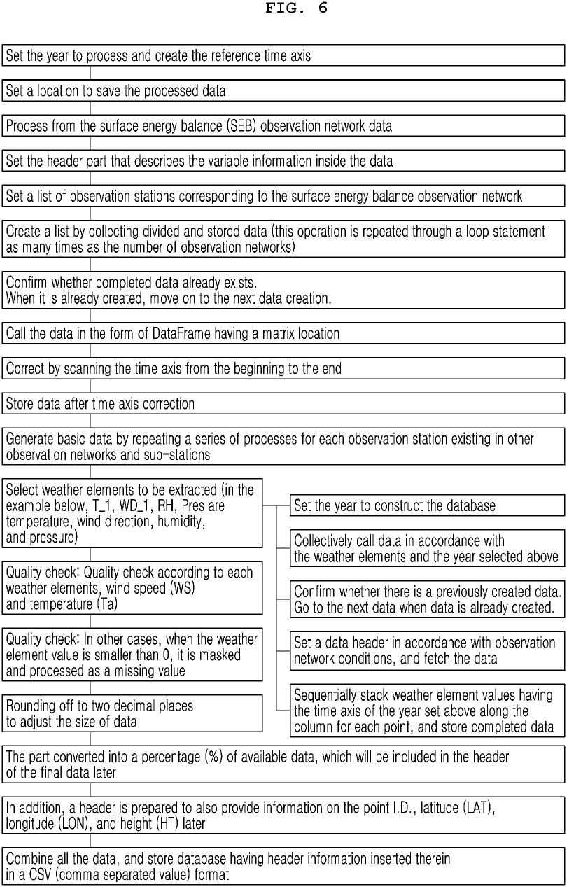

FIG. 6 is a view showing a Python-based pseudo code for implementing an integrated management method of an urban customized weather database according to an embodiment of the present disclosure. Referring to FIG. 6, based on the Python programming language, urban weather observation data collected from different urban weather observation networks may be constructed as a database of a desired weather element and analysis period.

As described above, the Python-based integrated management method of an urban customized weather database according to the embodiments of the present disclosure may be configured to be implemented by a computing system. Although the computing system may include, for example, a server, a desktop computer, a notebook computer, a workstation, a personal digital assistant (PDA), a mainframe, one or more various types of digital computing devices, and the like, it is not limited thereto.

The computing system may include one or more processors, one or more memories, and the like. Each of the processors, memories, and the like may be interconnected using various wired/wireless communication means and/or buses. According to embodiments, a plurality of processors and/or a plurality of memories may be used, or a plurality of computing devices may be connected to be able to communicate. Each computing device is, for example, a server, a group of servers, or a multi-processor system, and may provide some of necessary operations. When a plurality of functions and/or operations is performed by the processor(s), the plurality of functions and/or operations may be performed by an arbitrary number of processors included in an arbitrary number of computing devices. In addition, when a function and/or an operation is performed by a processor(s), the function and/or operation may be executed by, for example, an arbitrary number of processors included in an arbitrary number of computing devices in a distributed computing system.

The memory(s) may be non-volatile memory unit(s) for storing information in a computing system. The memory(s) may be or include, for example, a floppy disk, a hard disk, a magnetic disk, an optical disk, a magnetic tape, a flash memory, a solid-state memory, various forms of computer readable media, or the like.

One or more of methods as described above may be configured to be implemented when instructions stored in the memory (s) are executed by the one or more processor (s). These methods may be implemented by a digital electronic circuit, an integrated circuit, an application specific integrated circuit (ASIC) , computer hardware, firmware, software, and/or a combination of these. These various implementations may include implementations on one or more computer programs executable and/or interpretable on a programmable system including at least one programmable processor configured to execute the instructions.

These computer programs (also referred to as programs, software, software applications, or codes) may be implemented in a high-level procedure-oriented and/or object-oriented programming language, and/or in an assembly/machine language.

Components of different embodiments described in the present disclosure may be combined to form other embodiments not specifically described above. The components may be excluded from the processes, computer programs, databases, and the like described in the embodiments of the present disclosure without affecting the functions and/or operations thereof.

In addition, logical flows illustrated in the drawings do not require a specific order or a sequential order shown in the drawings to achieve a desirable result. It should be understood that the order for performing a specific operation or the order of steps is not important as long as the embodiments described in this disclosure are maintained to be operable. In addition, two or more steps or operations may be performed simultaneously.

Although the embodiments described in the present disclosure have been shown and described in connection with specific embodiments, those skilled in the art should understand that various changes can be made in the form and detailed descriptions without departing from the spirit and scope of the claims as defined by the appended claims.

What is claimed is:

1. A Python-based integrated management method of an urban customized weather database, the method for constructing urban weather observation data into an integrated database, and comprising the steps of:
storing raw urban weather observation data collected from a plurality of urban weather observation networks as first files of a predetermined format according to an order of observation time at each observation point of the urban weather observation networks;
extracting data of each observation point of the urban weather observation networks from the stored first files according to the order of observation time, for a predetermined weather element and analysis period;
masking observation values belonging to a predetermined masking condition, among observation values included in the extracted data; and
storing the masking-processed data as a second file.

2. The method according to claim 1, wherein the urban weather observation networks include Road Weather Information (RWI), Surface Energy Balance (SEB), Integrated Meteorological Sensor (IMS), and Urban-Boundary-Green (UBG).

3. The method according to claim 1, wherein the predetermined format includes a CSV format, and as many first files as a number (n×y) obtained by multiplying the number (n) of all observation points included in the urban weather observation networks by the number (y) of observation periods per year are stored.

4. The method according to claim 1, wherein the predetermined weather element includes at least one weather element selected from a group configured of air temperature, wind direction, wind speed, maximum wind direction, maximum wind speed, daily precipitation, atmospheric pressure, rainfall detection, hourly precipitation, humidity, road surface condition, net radiation, total radiation, reflected radiation, water film thickness, salt concentration, solar radiation, downward shortwave radiation, upward shortwave radiation, downward longwave radiation, upward longwave radiation, underground temperature, road surface temperature, freezing point temperature, infrared surface temperature, contact-type surface temperature (south), contact-type surface temperature (north), net shortwave radiation, net longwave radiation, albedo, water vapor pressure, soil heat flux, soil temperature, soil moisture, average wind direction per minute, average wind speed per minute, soil average temperature, average east-west wind, average north-south wind, east-west wind anomaly, north-south wind anomaly, average wind speed anomaly, average soil moisture, daily maximum temperature, daily minimum temperature, daily maximum humidity, daily minimum humidity, daily maximum wind speed, and daily maximum wind direction.

5. The method according to claim 1, wherein the predetermined analysis period includes an annual period.

6. The method according to claim 1, wherein the step of storing as first files of a predetermined format according to an order of observation time includes the step of storing, when there is a plurality of observation values for one weather element for each observation point at the same observation time, only one of the observation values for the weather element.

7. The method according to claim 1, wherein the predetermined masking condition includes masking, among the extracted observation values, negative values, values exceeding 75, and values of which the difference from a previous observation value is greater than 10 as missing values when the predetermined weather element is wind speed, masking, among the extracted observation values, values smaller than -90 and values greater than 60 as missing values when the predetermined weather element is air temperature, and masking, among the extracted observation values, negative values as missing values when the predetermined weather element is not wind speed nor air temperature.

8. The method according to claim 1, wherein the second file further includes a ratio of non-missing values among all observation values with respect to the predetermined weather element.
